(19) United States
(12) Patent Application Publication
(10) Pub. No.: US 2024/0242284 A1
(43) Pub. Date: Jul. 18, 2024

(54) STEGANOGRAPHIC ASSET VALIDATION

(71) Applicants: Christiana Cacciapuoti, Brooklyn, NY (US); Elan Ashendorf, Staten Island, NY (US)

(72) Inventors: Christiana Cacciapuoti, Brooklyn, NY (US); Elan Ashendorf, Staten Island, NY (US)

(21) Appl. No.: 18/156,201

(22) Filed: Jan. 18, 2023

(51) Int. Cl. G06Q 40/06; H04L 9/06

(52) U.S. Cl. CPC G06Q 40/06; H04L 9/0643

(57) ABSTRACT

Disclosed are methods, systems, and non-transitory computer readable memory for generating validation-ready assets. For instance, a method may include receiving, from a user device associated with a user, an initial asset; for one or more pixel values of the initial asset, modifying at least one least significant bit, thereby generating a modified asset that is based on the initial asset; generating a user identifier configured to serve as an identifier for the user; and embedding, in the modified asset, data that is based on at least the user identifier by, for the one or more pixel values, modifying the at least one least significant bit of the modified asset, whereby embedding the data in the modified asset generates an embedded asset that is configured to be analyzed to validate the embedded asset.

### TECHNICAL FIELD

Various aspects of the present disclosure relate generally to systems and methods for generating validation-ready assets and validating information relating to assets and, more particularly, to systems and methods for embedding an identifier and/or an asset hash in an asset.

### BACKGROUND

Verifying claims regarding digital assets is generally difficult. For example, there is a significant market for “original” or “limited edition” digital images, which can be associated with a nonfungible token (NFT) to create scarcity and protect the image's value. The value of these NFTs depends, however, on the accuracy of the claim on which the purported scarcity is based. For example, if an image-containing NFT is valued based on a claim that the image's artist minted only a small number of NFTs containing that image, the value of that NFT depends on that claim being true.

There are many other scenarios in which it is important to verify claims regarding a digital asset. For example, a claim may be made that an image was generated by a trusted actor (e.g., a reputable reporter) who is known to be located in a particular area at a particular time. For example, an image may show political or commercially significant events—such as deployment of military vehicles, scenes of violence, or the presence of a political figure—and it may be important to verify that the image was truly generated by a trusted actor and is not likely to be a forgery. By verifying that the image was generated by a particular individual, it may also be possible to more confidently assess the location at which the image was generated.

At present, there are no accessible solutions that allow users to readily verify a claim regarding an image. Further, there are no solutions that allow users who create images to allow those images to be readily verified.

The present disclosure is directed to overcoming one or more of these above-referenced challenges.

### SUMMARY OF THE DISCLOSURE

According to certain aspects of the disclosure, systems, methods, and computer readable memory are disclosed for generating validation-ready assets and validating information relating to assets.

In some cases, a system for generating validation-ready assets may include one or more processors; and a memory storing instructions. The instructions may when executed by the one or more processors, be configured to cause the system to: receive, from a user device associated with a user, an initial asset; for one or more pixel values of the initial asset, modify at least one least significant bit, thereby generating a modified asset that is based on the initial asset; generate a user identifier configured to serve as an identifier for the user and/or the user device; and embed, in the modified asset, data that is based on at least the identifier by, for the one or more pixel values, modifying the at least one least significant bit of the modified asset; wherein embedding the data in the modified asset generates an embedded asset that is configured to be analyzed to validate the embedded asset.

In some cases, a computer-implemented method for generating validation-ready assets, may include: receiving, from a user device associated with a user, an initial asset; for one or more pixel values of the initial asset, modifying at least one least significant bit, thereby generating a modified asset that is based on the initial asset; generating a user identifier configured to serve as an identifier for the user and/or the user device; and embedding, in the modified asset, data that is based on at least the user identifier by, for the one or more pixel values, modifying the at least one least significant bit of the modified asset; wherein embedding the data in the modified asset generates an embedded asset that is configured to be analyzed to validate the embedded asset.

In some cases, a system for validating information relating to assets may include one or more processors; and a memory storing instructions. The instructions may when executed by the one or more processors, be configured to cause the system to: receive an asset comprising a plurality of pixels, each pixel having a respective pixel value comprising a plurality of bits; determine the asset has embedded data in one or more least significant bits of the plurality of pixel values; extract, from the asset, the embedded data in the one or more least significant bits of the plurality of pixel values; and analyze the embedded data to determine a source of the asset.

In some cases, computer-implemented method for validating information relating to assets, may include: receiving an asset comprising a plurality of pixels, each pixel having a respective pixel value comprising a plurality of bits; determining the asset has embedded data in one or more least significant bits of the plurality of pixel values; extracting, from the asset, the embedded data in the one or more least significant bits of the plurality of pixel values; and analyzing the embedded data to determine a source of the asset.

Additional objects and advantages of the disclosed technology will be set forth in part in the description that follows, and in part will be apparent from the description, or may be learned by practice of the disclosed technology.

It is to be understood that both the foregoing general description and the following detailed description are exemplary and explanatory only and are not restrictive of the disclosed technology, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed technology.

FIG. 1 depicts an example environment in which a system generates validation-ready assets and validates information relating to assets.

FIG. 2 depicts a block diagram showing exemplary operations of the system to register and maintain a custody chain for an ID in a data structure of the system.

FIG. 3 depicts a block diagram showing exemplary operations of the system to generate validation-ready assets.

FIG. 4 depicts a block diagram showing exemplary operations of the system to validate information relating to assets.

FIG. 5 depicts a diagram showing an exemplary process for embedded data in assets.

FIGS. 6A-6F depict graphical user interfaces for a registration process and a generation process for validation-ready assets.

FIGS. 7A-7C depict graphical user interfaces for a validation process for validation-ready assets.

FIGS. 8A-8B depict flowcharts of exemplary routines.

FIG. 9 depicts an example system that may execute techniques presented herein.

### DETAILED DESCRIPTION

Various aspects of the present disclosure relate generally to generating validation-ready assets and validating information relating to assets. As discussed in detail herein, systems of the present disclosure may provide content authentication services, privacy services, content moderation services, second factor authentication services, and/or auto-captcha services.

In some cases, the systems of the present disclosure may generate an identifier (ID) to identifier a user, such as a user ID, a device ID, or combinations thereof. In some embodiments, a device ID may be statistic, such as photo response non-uniformity of a plurality of images from an asset generation device (e.g., a digital camera). In other embodiments, the ID may be a number or string, which may be, for example, randomly generated or provided by a user. The systems of the present disclosure may embed (encrypted or unencrypted) the ID into digital assets. The user may then elect to publish or otherwise share the assets with other individuals, who may submit the assets for validation using the embedded ID. In this manner, when the system is presented with an asset that has the ID embedded in the asset, the system may authenticate the source of the asset.

In some cases, the systems of the disclosure may determine a deterministic value for an asset (e.g., an asset hash) and also embed the deterministic value into the digital asset. For example, when the system is presented with an asset that has the deterministic value embedded in the asset, the system may verify that the asset has (or has not) been modified or in tampered with by third parties.

In some cases, the systems of the present disclosure may register users and associate those users with particular device IDs. In this manner, users may prove they have possession of an asset generation device, and the system may prevent that asset generation device from becoming associated with any other user.

In some cases, a user may provide both user credentials (e.g., a user login and password) and an asset that can be statistically corroborated as having been generated by a device that has been associated with that user. In this manner, the system may effectively apply a multi-factor authentication before the user is permitted to generate validation-ready images.

In some cases, the systems of the present disclosure may track digital assets and alert a user if a subsequently processed asset has an ID or asset hash that corresponds to the user. In this manner, the systems of the present disclosure may enable remediation privacy services (e.g., alerting to a breach in privacy).

In some cases, the systems of the present disclosure may provide content moderation service. For instance, the system of the present disclosure may check, when a new digital asset is to be added to an asset repository, whether any digital asset already in the asset repository has a same asset hash. In this manner, duplicates or unauthorized re-publication of digital assets may be tracked, blocked, and/or reported.

Thus, methods and systems of the present disclosure may be improvements to computer technology. For instance, methods and systems of the present disclosure may be improvements to digital asset authentication, computer system security, digital asset privacy, and/or content moderation.

### Environment

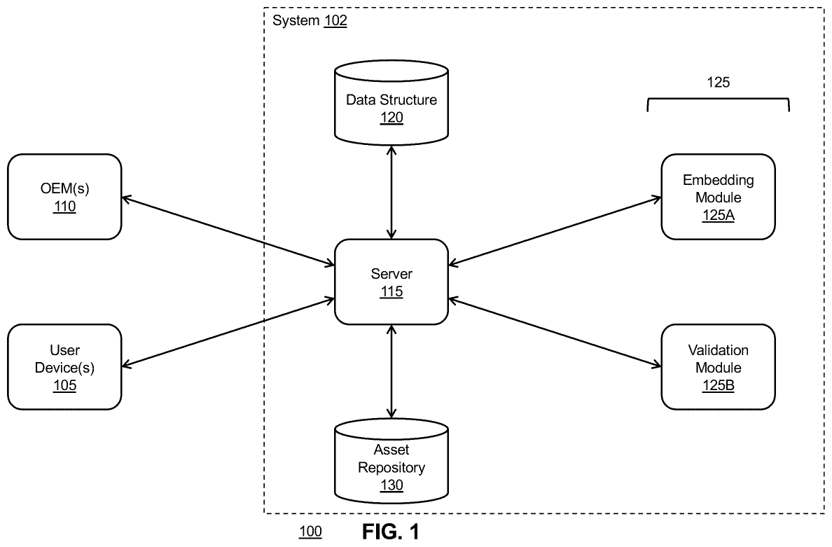

FIG. 1 depicts an example environment 100 in which a system 102 generates validation-ready assets and validates information relating to assets. The environment 100 may include user device(s) 105, and system 102. Optionally, the environment may also include original equipment manufacturer(s) (OEM(s)) 110. The system 102 may include a server 115, a data structure 120, a backend 125 (with an embedding module 125A and a validation module 125B), and an asset repository 130. The system 102 may generate validation-ready assets for user device(s) 105 associated with users. The system 102 may also validate information relating to assets in response to receiving requests (from user device(s) 105, which may be associated with the same or different users) requesting validation of an asset and/or a claim regarding a claimed source of an asset. Generally, an asset may be any digital media, such as, but not limited to, images, NFTs, logos, audio, video, text, webpages, and the like. While certain aspects of the disclosure discuss generating validation-ready assets in the context of images, the same (or similar) embedding of data (e.g., an ID and/or asset hash) into digital media may be applied to audio, video, text, webpages, and the like.

The user device(s) 105 may (hereinafter referred to as “user device 105” for clarity of reference) may be various different types of devices, including asset generation devices (digital cameras, video recorders, audio recorders, and the like), computing devices (e.g., tablet, mobile phone, desktop computer, and the like), extended reality (XR) devices (e.g., augmented reality devices, virtual reality devices, mixed reality devices, and the like), and the like, that communicate using wired (e.g., ethernet, and the like) or wireless communication standards (e.g., WIFI, and the like). In some cases, the user device 105 may be a smartphone with an integrated digital camera. In some cases, the user device 105 may be a computing device operated by a user to process assets generated by asset generation devices. In some cases, the user device 105 may be a computing device operated by a user to enter data and/or interact with remote servers/applications, such as a mobile phone, a laptop computer, a desktop computer, tablet, a smart watch, and the like. In some cases, the user device 105 may be an XR device operated by a user to interact with XR applications, such as virtual reality devices, augmented reality devices, mixed reality devices, and the like. Generally, one or more such user devices 105 may connect to the system 102, via one or more wireless or wired communications systems, such as local networks, private networks, or the internet. In this manner, the user devices 105 may connect to and communicate with the system 102, as discussed herein.

Users, via user devices 105, may register user devices 105 and/or asset generation devices with the system 102, to thereby associate the user devices 105 and/or asset generation devices with the users. In some cases, the user devices 105 may be integrated with asset generation devices. For instance, a mobile phone may have a microphone (to record audio) and a camera (to record images or video). A user may be an individual (e.g., a person) or an organization (e.g., a business, non-profit, and the like). In this manner, the system 102 may generate validation-ready assets for users, as discussed herein.

The OEM(s) 110 may manufacturer (or assemble) the user devices 105 and/or the asset generation devices. In some cases, the OEM(s) 110 may register the user devices 105 and/or the asset generation devices with the system 102, to thereby associate the user devices 105 and/or asset generation devices with the OEM that manufactured (or assembled) the user devices 105 and/or the asset generation devices. Subsequently, when a user obtains possession (e.g., ownership or lease) of a user device 105 and/or asset generation device from an OEM or another user, the user (via a user device 105) may submit a custody request to the system 102 to associate the user with the user device 105 and/or asset generation device. In some cases, the user device 105 and/or asset generation device may not have been registered previously with the system 102 (e.g., the system 102 may determine whether the user device 105 and/or asset generation device is already registered) and treat the custody request as a request to register the user device 105 and/or asset generation device. In this manner, the system 102 may associate users with user devices 105 and/or asset generation devices, as the user devices 105 and/or the asset generation devices change possession between OEMs and users.

In some cases, the system 102 may be a software as a service platform hosted on a server, in the cloud, and/or on a decentralized network, and the system 102 may be managed by an operating organization. In some cases, the system 102 may be a blockchain-hosted software as a service, where different functional aspects are hosted on different nodes of a blockchain, and managed by a consensus structure or decentralized autonomous organization (DAO). In some cases, portions of the system 102 may be managed by the operating organization (e.g., the server 115, the embedding module 125A, and the validation module 125B), while other portions of the system 102 may be managed by other operating organizations, consensus structure, or DAO (e.g., the asset repository 130 or the data structure 120). In some cases, the operating organization may provide validation services to the asset repository 130 and/or publish certain data via the data structure 120 that is publicly facing, as discussed herein.

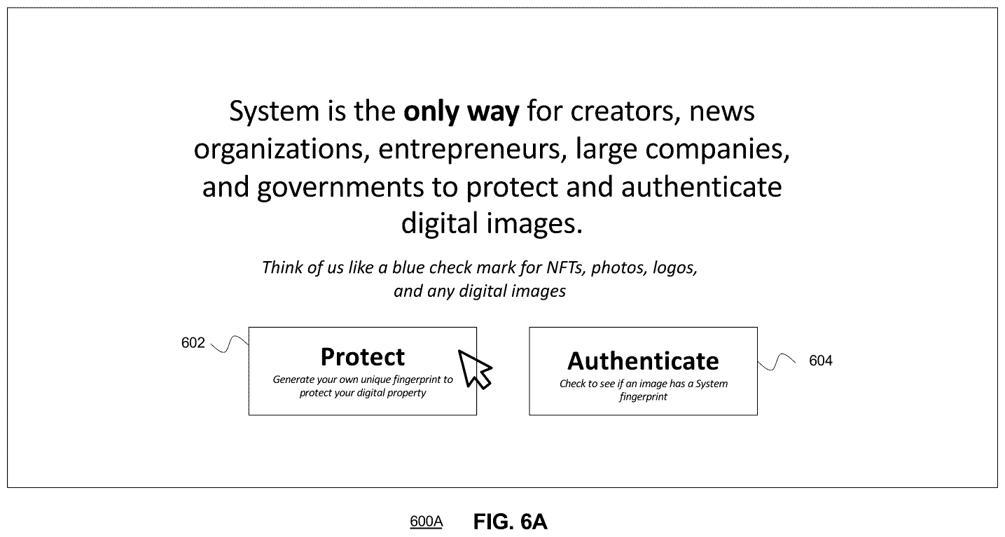

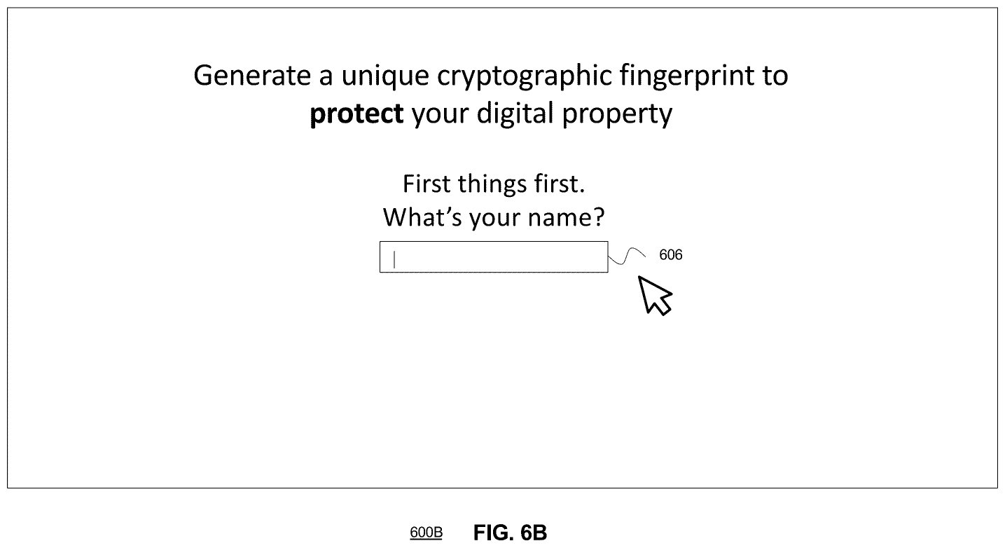

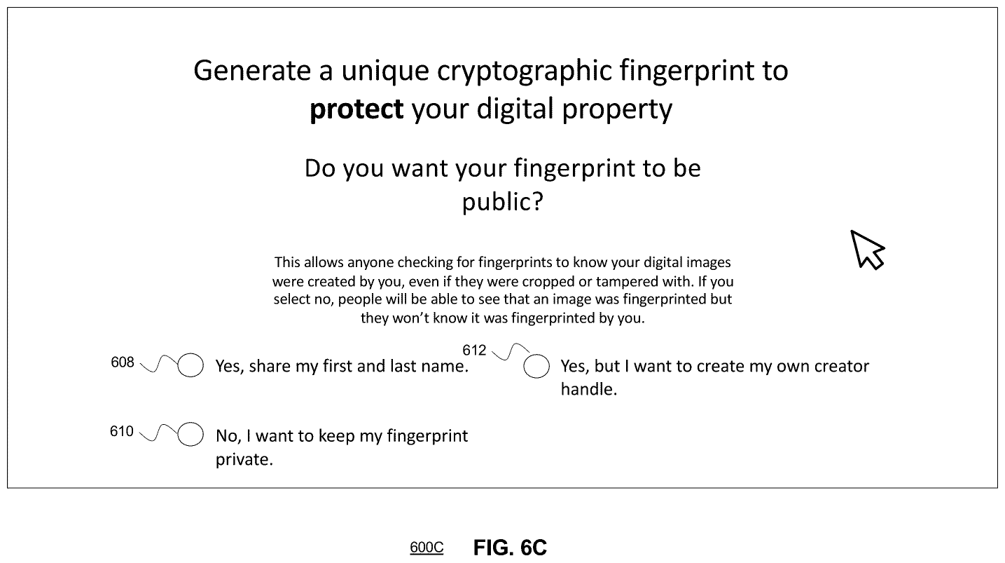

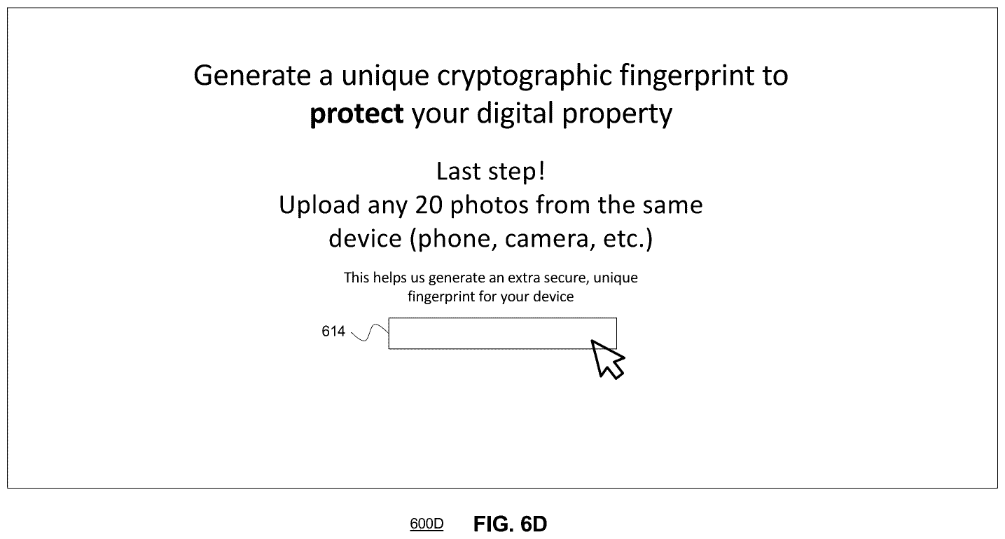

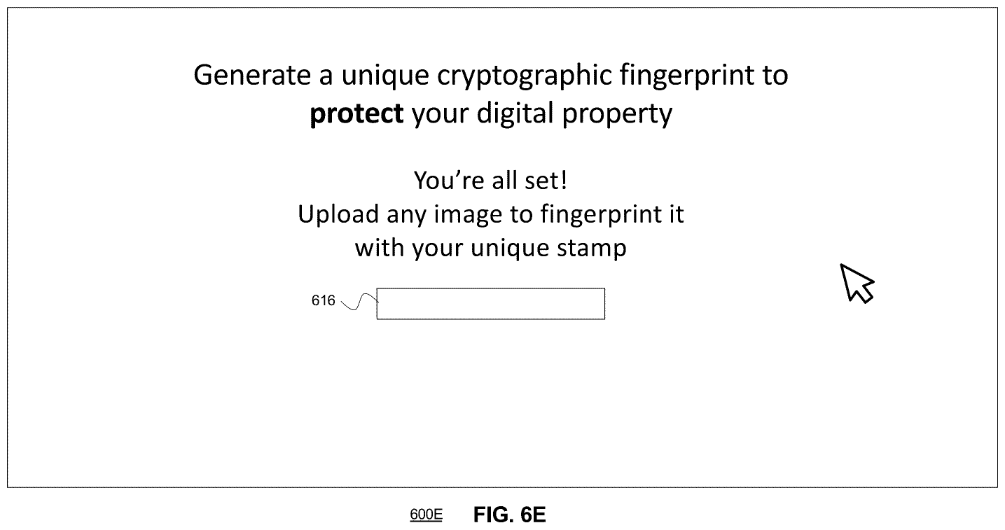

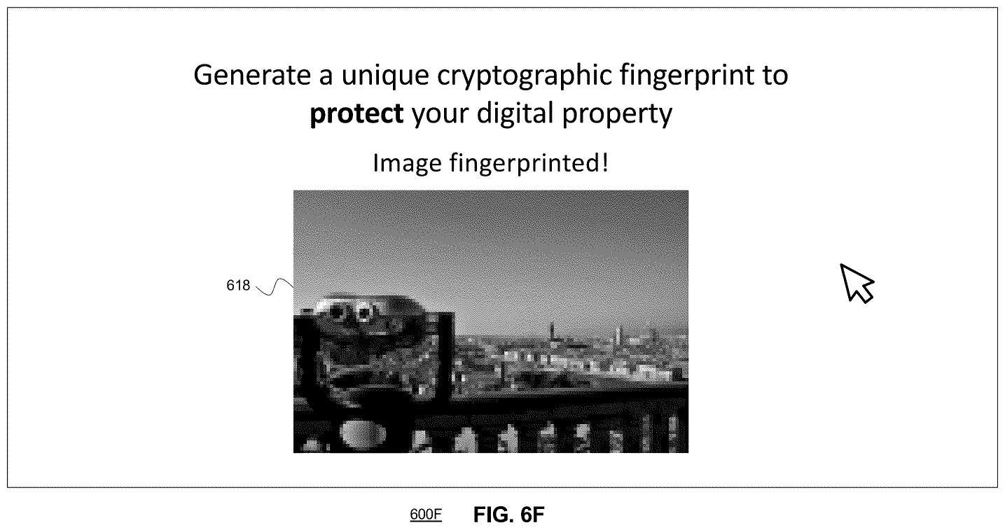

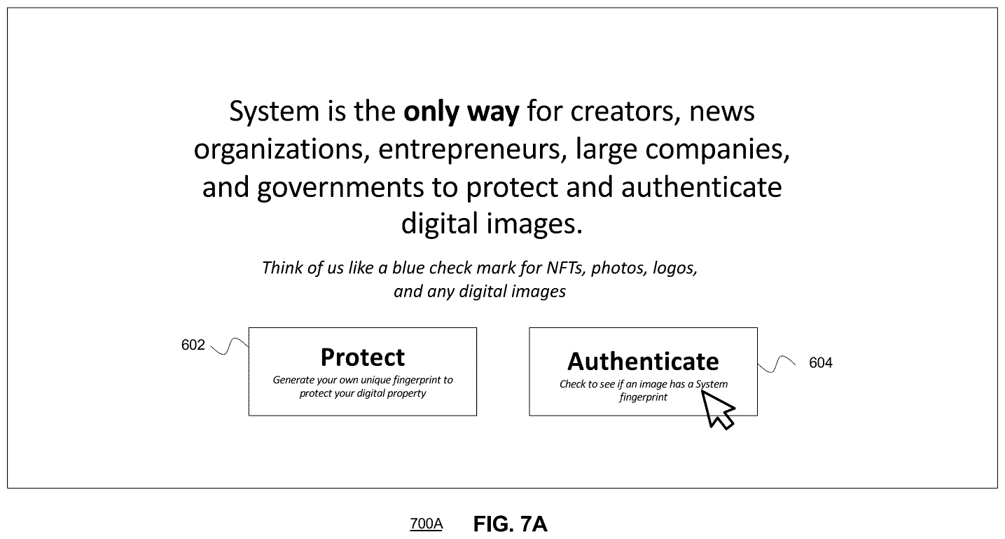

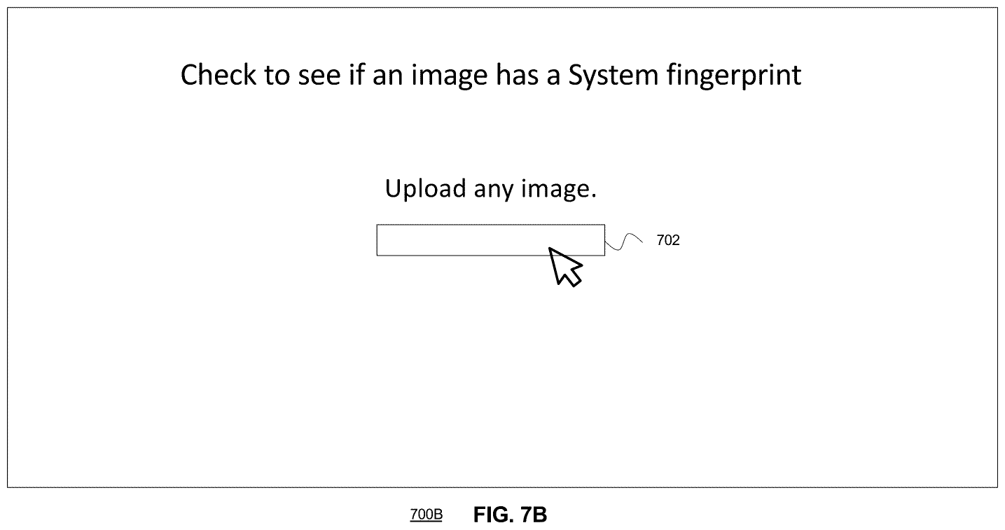

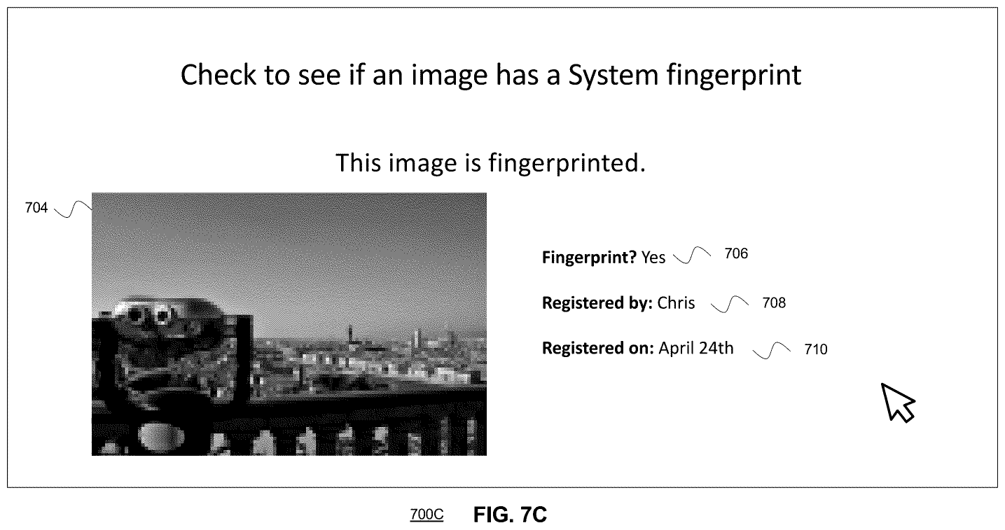

The server 115 may be a frontend of the system 102. The server 115 may be configured to serve web assets (e.g., webpages, mobile application data, and the like), so that users may interact with the system 102, via user devices 105. The server 115 may manage user accounts for users (e.g., account creation, login authentication, settings, and the like), in accordance with user requests, via user devices 105. In some cases, the server 115 may manage a registration process in response to receiving a registration request or custody request from a user device 105. In some cases, the server 115 may relay relevant requests from the user devices 105 to the embedding module 125A and the validation module 125B, and relay result messages to the user devices 105 from the embedding module 125A and the validation module 125B. In some cases, the server 115 may transmit to user devices 105 data to display graphical user interfaces, such as those discussed below with reference to FIGS. 6A-7C.

As a part of the registration process, the server 115 may generate an ID based on a registration request received from a user device 105 associated with a user. In particular, the ID may be a user identifier configured to serve as an identifier for the user. The ID may be a user ID (for the user), a device ID for the user device 105 or an asset generation device, or a combination of both. In some embodiments, the user ID may be a unique ID (to the system 102) to identify the user, and the server 115 may manage the user ID as a part of managing the account of the user. In some cases, the device ID may be an identifier of the device, such as one or combinations of: a serial number, a mac address, device type, device model, device characteristics (e.g., device name, OS, application, etc.), network address, internet address and like, and/or a derivative based on any of the foregoing (e.g., a hash of certain device characteristics).

In some cases, the device ID may be a statistic that is unique to an asset generation device used by the user. For example, the server 115 may generate the statistic by analyzing a photo response non-uniformity of a plurality of assets (e.g., images) generated by a same asset generation device provided by the user device 105. For instance, the asset generation device may be an integrated camera of the user device 105 or a digital camera owned by the user and the assets are provided by the user device 105. The photo-response non-uniformity may be determined by analyzing multiple assets from a known asset generation device to filter out the asset content, thereby isolating or bolstering the asset generation device noise signature embedded into all of the assets generated with asset generation device.

The data structure 120 may store a custody chain. The custody chain may store associations between an account of a user (e.g., an account ID) and an ID. The server 115 may update the association as registration requests are received from different users, via user devices 105. In some cases, an account of a user (e.g., an organization) may be associated with more than one ID. In some cases, an account of a user (e.g., an individual) may be associated with only one ID. The ID may be a user ID (for the user), a device ID for a user device 105 or an asset generation device, or a combination of both. In some cases, the data structure 120 may be a database (e.g., not publicly facing). The database may be a relational database (e.g., SQL database, and the like), or a non-relational database (e.g., NoSQL, and the like). In some cases, the data structure 120 may be a ledger hosted on a blockchain (e.g., publicly facing). The ledger may be a Merkle tree and the like. In some cases, the account ID and/or account information (if stored in the data structure 120) may be encrypted before it is stored in the data structure 120. In some cases, the ID may be encrypted (e.g., by the server 115 using a public cryptographic key of a user, or by the user device using a private cryptographic key of the user) before it is stored in the data structure 120. In some cases, a user (or user device 105 associated with the user) may store a private key (e.g., a cryptographic key) to decrypt the information. In some cases, the system 102 may store (separately from the data structure 120) the private key to decrypt the information.

The embedding module 125A and the validation module 125B may be hosted on the server 115 or on a different server or node of the system 102. The embedding module 125A and the validation module 125B may be combined or separate. The embedding module 125A and the validation module 125B are depicted as separate herein to clarify their respective aspects.

The embedding module 125A may generate an embedded asset that is configured to be analyzed to validate the embedded asset. The embedded asset may have data embedded (“embedded data”) that is configured to validate the embedded asset. The data to be embedded may include a device or user ID. In some embodiments, the data to be embedded may additionally or alternatively include a deterministic value relating to the asset (e.g., a hash of the asset). The data to be embedded may be encrypted before embedding. The data to be embedded has a number of bits. The number of bits may be dynamic (e.g., based on a bit size of the ID and/or deterministic value and any other data) or fixed (e.g., includes padding). The embedded data may also include one or combinations of: a fingerprint bit sequence, a checksum, the user, the user device 105, copyright information, NFT data, and/or metadata of the image (e.g., time, place, etc. for the asset that was generated). A fingerprint bit sequence may be a defined sequence of bits (for a defined set of pixels) that indicate the asset is an embedded asset. For instance, the fingerprint bit sequence may have a bit length that makes it statistically unlikely an asset would have the same bit values as the fingerprint bit sequence. The embedding module 125A may also embed a fingerprint mark embedded into the asset content. A fingerprint mark may be a defined arrangement of pixels (e.g., values and placement) that indicate an asset is embedded.

In some cases, the embedded asset may be any image embedded with the embedded data. For instance, the image may be an image generated by a same asset generation device is associated with the ID (e.g., the statistic that is unique to the asset generation device used by the user), or the image may a digital image (e.g., NFT, logo, and the like), or an image taken by a different asset generation device.

To generate the embedded asset, the embedding module 125A may receive an initial asset from a user device associated with a user. For instance, the embedding module 125A may receive the initial asset via the server 115 as a part of receiving an embed request from the server 115.

The embedding module 125A may then, for one or more pixel values of the initial asset, modify at least one least significant bit, thereby generating a modified asset that is based on the initial asset. For instance, the embedding module 125A may determine the one or more pixel values of the initial asset to modify by using any of the following exemplary selection processes: (1) randomly selecting a number of pixels, where the number of randomly selected pixels equal a number of bits of the embedded data (the randomly selected pixels may be embedded in metadata to indicate the image is embedded); (2) selecting a pixels from a defined region (e.g., first or last portion of pixels, a corner, a middle, and the like), where the pixels of the defined region has a number equal to the number of bits of embedded data; (3) evenly selecting pixels from the initial image (e.g., every X number of pixels) until a number of pixels equal to the bits of embedded are selected; (4) selecting pixels from defined locations (e.g., corners of image, midpoint of row, midpoint of column, etc.) for the number of bits of the embedded data; or (5) selecting all of the pixels in an asset. In some cases, more than one bit of a pixel value may be modified (e.g., the two least significant bits of a pixel value may be modified). This may increase the amount of data that can be stored in the image or reduce the number of pixels that need to be modified, at the cost of greater distortion to the asset. In some cases, the embedding module 125A may modify the one or more pixels by setting the least significant bit (or two or more least significant bits, etc.) to a defined value (e.g., 0 or 1).

The embedding module 125A may then, embed data in the modified asset to generate an embedded asset. The data to be embedded may include at least data that is based on at least the ID. The data to be embedded may additionally or alternatively include a deterministic value related to the initial asset or the modified asset (e.g., a hash of any of these assets). In some embodiments, the embedding module 125A may embed the data by, for the one or more pixel values, modifying the at least one least significant bit of the modified asset. For instance, the embedding module 125A may embed the embedded data, discussed above, in the same the at least one least significant bit of the for the one or more pixel values. For instance, the embedding module 125A may set each least significant bit (or two or more least significant bits) of the one or more pixels to a bit of the embedded data in a defined sequence.

In some cases, the appearance of the embedded asset may be indistinguishable to the human eye from that of the initial asset. For example, all pixel values of the embedded asset may be less than a threshold different than corresponding pixel values having a same position in the initial asset. For example, each of the pixel values (expressed as an average of red-green-blue components or in grayscale) for the embedded asset may be within 5% of the corresponding values for the correspondingly located pixels in the initial image. For example, if a pixel located in the (0,0) position in the initial image has RGB values that average to 100, in the case where the threshold is 5%, the pixel located in the (0,0) position in the embedded image may have RGB values that average to a value between 95 and 105, and the same relationship may be true for the remainder of the pixels in the initial and embedded images. In some cases, the threshold may be 5%, 4%, 3%, 2%, 1%, 0.5%, 0.1%. In other cases, the threshold may be an discrete value, rather than a percentage. For example, if a pixel located in the (0,0) position in the initial image has RGB values that average to 50, in the case where the threshold is 5, the pixel located in the (0,0) position in the embedded image may have RGB values that average to a value between 45 and 55, and the same relationship may be true for the remainder of the pixels in the initial and embedded images. In some cases, the threshold may be 10, 5, 4, 3, 2, 1.

As mentioned above, in some cases, the embedded data includes the deterministic value. The embedding module 125A may generate the deterministic value using the modified asset. In other cases, the embedding module 125A may generate the deterministic value using the initial asset. The deterministic value may be configured to serve as an asset identifier. In some cases, the deterministic value is a hash of the modified asset. The hash may be a SHA-2 hash, a MD5 hash, or the like.

The asset repository 130 may be a content delivery network of digital assets, a NFT marketplace, or a blockchain digital asset content management system. In some cases, the system 102 (e.g., the embedding module 125A) may determine whether the deterministic value exists in a data repository comprising deterministic values associated with previously received assets of the system 102 (generated from modified previously received assets of the system 102) and/or assets of the asset repository 130 (generated from modified assets of the asset repository 130). For instance, the embedding module 125A may determine whether the deterministic value matches any deterministic value in the data repository. If so, the embedding module 125A may determine the asset already has been processed (by the system 102) or published/minted (by the asset repository 130), and deny an embed request, inform the asset repository 130, and the like. If not, the embedding module 125A may proceed with the embed request and provide (to the user device 105)/publish the embedded asset in the asset repository 130. In this manner, the system 102 may confirm the initial asset is unique (e.g., not a copy of an existing asset) as compared to previously received assets of the system 102 or of the asset repository 130, thereby increasing digital asset tracing and/or preventing theft/unauthorized republication/reminting.

The validation module 125B may analyze assets to validate the assets as embedded asset (or not). For instance, the validation module 125B may receive an asset (in the case of an image, the asset comprising a plurality of pixels, each pixel having a respective pixel value comprising a plurality of bits) from a user device 105, via the server 115, as a part of an authentication request. To validate assets, the validation module 125B may determine the asset has embedded data in one or more least significant bits of the plurality of pixel values. For instance, the validation module 125B may determine the asset has embedded data by: (1) reading metadata of the asset that indicates the asset has been fingerprinted; (2) scanning content of the asset for a fingerprint mark; or (3) reading bit values of the asset to see if a fingerprint bit sequence is matched.

The validation module 125B may then extract the embedded data from the asset. For instance, the validation module 125B may determine the one or more least significant bits of the plurality of pixel values in a same manner as for embedding the embedded data. That is, the validation module 125B may select the one or more pixels (e.g., in accordance with metadata, pre-defined pixels, and the like), as discussed above. The validation module 125B may then copy bit values from the least significant bits for those pixels to thereby extract the embedded data. In some embodiments, the validation module 125B may decrypt the extracted data. In some embodiments, the validation module 125B may retrieve a key that is associated with a user that is claimed to be the author of the image. If the key is successful in decrypting the embedded data, this may be assessed as confirming or corroborating the claim that the user whose key was successfully applied is, in fact, the author of the image. If they key is not successful in decrypting the embedded data, the system may determine that the authorship claim is incorrect or that an assessment cannot be made.

The validation module 125B may analyze the embedded data to determine a source of the asset. For instance, in some cases, the validation module 125B may extract at least an ID and/or a deterministic value from the embedded data. In some cases, the validation module 125B may determine whether the ID is an ID of the system 102. For instance, the validation module 125B may determine if the ID matches any ID in the data structure 120; if the ID matches, the validation module 125B may determine the user account associated with the ID (e.g., by retrieving the account ID from the data structure 120); if the ID does not match, the validation module 125B may determine the asset has been tampered with, a user account has been deleted, or an error has occurred (e.g., an indeterminant result).

In some cases, the validation module 125B may determine whether the extracted deterministic value is authentic. For instance, the validation module 125B may modify the least significant bits of the asset to generate a modified asset. That is, the validation module 125B may normalize the bit values, so as to create a modified asset (which may match, on a bit-wise basis, the modified asset generated by the embedding module 125A, if the asset has not been tampered with or embedded data embedded into a different asset). For instance, like the embedding module 125A, the validation module 125B may set the least significant bit (or two or more least significant bits, etc.) to a defined value (e.g., 0 or 1); or (2) adjust the least significant bit (or two or more least significant bits, etc.) in accordance with a normalization process. The validation module 125B may then generate a deterministic value using the modified asset. The deterministic value may be configured to serve as an asset validator. In some cases, the deterministic value is a hash of the modified asset (e.g., a validation hash). The hash may be a SHA-2 hash or a MD5 hash, and the like. The validation module 125B may then determine whether the extracted deterministic value (e.g., an asset hash) is the same as the generated deterministic value (e.g., the validation hash); if they are the same, the validation module 125B may determine the asset has not been tampered with or the embedded data has not been embedded into a different asset (e.g., that this is the same asset as provided by the user to generate an embedded asset); if they are different, the validation module 125B may determine the asset has been tampered with or the embedded data has been inserted into a different asset (e.g., that this is not the same asset as provided by the user to generate an embedded asset).

In some cases, only if both the ID and the deterministic value are authenticated, the validation module 125B may transmit a result message indicating a validated asset. In some cases, the result message may include user data (such as handle, name, organization, etc.), in accordance with user account settings associated with the source of the asset (e.g., that requested generation of the embedded asset that is the asset). In some cases, if either the ID or the deterministic value are not authenticated, the validation module 125B may transmit a result message indicating a partial authentication (e.g., ID matches and deterministic value does not match, ID does not match and deterministic value does match). In some cases, if both the ID and deterministic value are not authenticated, the validation module 125B may transmit a result message indicating an error or affirmatively state the asset is not authenticated.

In some cases, the system 102 receives a claim regarding a claimed source of an asset. For instance, the server 115 may receive an authentication request that includes an asset and an indication of a user, handle, or ID. The validation module 125B may compare the claimed source against the source determined by analyzing the embedded data (e.g., the ID extracted from the embedded data). The validation module 125B may then generate an assessment as to whether the claim regarding the claimed source of the asset is valid. For instance, in the case the extracted ID corresponds to the user, handle, or ID of a user provided in the request, the validation module 125B may generate an assessment that the claimed source is valid and transmit a result message indicating the same (if user account settings allow public validation). In the case the extracted ID does not correspond to the user, handle, or ID of a user provided in the request, the validation module 125B may generate an assessment that the claimed source is invalid and transmit a result message indicating the same.

In some cases, the embedded data is encrypted, and the validation module 125B may decrypt the embedded data using a cryptographic key associated with the asset. The embedding module 125A may generate (or select) the cryptographic key when generating the embedded asset, and store the cryptographic key, e.g., in or separate from the data structure 120. The validation module 125B may retrieve the cryptographic key and decrypt the embedded data using the cryptographic key.

In some cases, the cryptographic key may be directly associated with the asset. For instance, the asset (e.g., metadata of the asset) or a non-encrypted portion of the embedded data may include a cryptographic key ID (or asset ID), and the validation module 125B may retrieve the cryptographic key based on the cryptographic key ID (or asset ID).

In some cases, the cryptographic key may be indirectly associated with the asset, via the user who embedded the asset. For instance, the asset (e.g., metadata of the asset) or the non-encrypted portion of the embedded data may include a user ID, and the validation module 125B may retrieve the cryptographic key based on the user ID. Alternatively, in some cases, the validation module 125B may transmit a decrypt request to a user device 105 associated with a user (as the user device 105/user may store the cryptographic key) to request the user device 105 to decrypt the encrypted embedded data; the validation module 125B may receive the embedded data from the user device 105 if the user/user device 105 decides to process the decrypt request.

In some cases, the validation module 125B may retrieve a cryptographic key associated with a claimed source (e.g., user, handle, or ID) and attempt to use the cryptographic key associated with the claimed source decrypt the embedded data. For instance, in response to receiving a validation request, the validation module 125B may determine a cryptographic key associated with the claimed source (e.g., associated with an account of the claimed source) and retrieve the cryptographic key. For example, the cryptographic key may thus be selected based on a claim whose validity is being assessed. In some embodiments, a user device may transmit to the system a message instructing the system to evaluate a claim that an asset was generated by Author A, and in response, the system may extract data from the asset and attempt to decrypt the data using a key associated with Author A. In the case the decryption attempt on the embedded data is successful, the validation module 125B consider the successful decryption as another factor in authentication of the embedded ID or asset hash. In the case that the decryption attempt on the embedded data is not successful (e.g., output is not coherent or expected format), the validation module 125B may transmit a result message indicating an error or that the claimed source is not authenticated as the source of the asset.

In some cases, the asset hash embedded in the embedded data is encrypted before it is included in the embedded data (which, as discussed above, may be encrypted as a separate encryption layer). The embedding module 125A may use a cryptographic key associated with the system 102 (a “system cryptographic key”) to encrypt the asset hash, and the validation module 125B may retrieve the system cryptographic key and decrypt the asset hash after it is extracted from the embedded data.

In some cases, the ID embedded in the embedded data is encrypted before it is included in the embedded data (which, as discussed above, may be encrypted as a separate encryption layer). The embedding module 125A may use a cryptographic key associated with the user (a “public cryptographic key”) to encrypt the ID, and the validation module 125B may determine whether the encrypted ID matches an encrypted ID stored in the data structure 120. In this manner, in the case the ID is or includes a device ID, the device ID is not exposed unless a user publishes a private cryptographic key.

In some cases, the validation module 125B may provide auto-captcha services or second factor authentication (2FA) services for computing systems (such as the system 102 or a different system or service). For instance, in the case of auto-captcha, registration with the system 102 may prove a user has a device with a minimum amount of computing ability (e.g., has an asset generation device). In this manner, the system 102 may block or deter bot farms, which may not use devices with integrated asset generation devices.

In the case of 2FA, after registration, the system 102 may request additional assets generated by a same asset generation device (e.g., integrated or otherwise to a user device 105) to second factor authenticate a user trying to login onto the system 102 or a different system or service (or perform an action on the system 102 or different system or service). For instance, the server 115 may process the additional assets, generate a new statistic by analyzing a photo response non-uniformity of additional assets, and compare the new statistic to a previous statistic (e.g., of the device ID when registered). The comparison may be probabilistic, such that an exact match may not be required to be considered sufficient similar. If the new statistic and the previous statistic match (or are sufficiently similar), the system 102 may second factor authenticate the user login (or action); if the new statistic and the previous statistic do not match (or are not sufficiently similar), the system 102 may deny the user login (or action). In this manner, systems may increase security by requiring a user to provide data from a physical device in their possession. For instance, the system 102 may require that the additional assets are generated with a time stamp after the 2FA process started.

In some cases, the system 102 may provide content moderation services to the asset repository 130. For instance, the system 102 (e.g., the embedding module 125A) may confirm that the asset hash of each newly requested asset for the asset repository 130 is unique (e.g., does not have a same hash as any existing asset in the asset repository 130). In this manner, content theft or unauthorized republication may be stopped.

In some cases, the system 102 may provide content authentication by processing authentication requests. For instance, the system 102 may indicate a digital asset is authenticate and from an indicated source, if the ID and asset hash are validated. In this manner, digital assets, such as news images and the like, may be validated as coming from a known source. Additionally, in this manner, fakes or manipulated digital assets may be identified as such when the authentication request (e.g., claiming a news organization generated the digital asset) does not authenticate the fake or manipulated digital asset.

In some cases, the system 102 may provide a privacy service to users. For instance, digital assets (e.g., screenshots) may be embedded with an asset hash of the digital asset with the ID in response to an embed request from a user. The system 102 may alert the user if the digital asset is published to the asset repository 130 or is processed by the system 102 at a later date. For instance, the system 102 may add the asset hash of the digital asset and/or the ID to a tracking list. If the system 102 detects the ID or asset hash during processing of assets at a later date (e.g., the system 102 checks the tracking list during normal processing), the system 102 may transmit an alert to the user associated with the tracking list. In this manner, tracing and privacy of digital assets for users may be increased.

### Example Operations

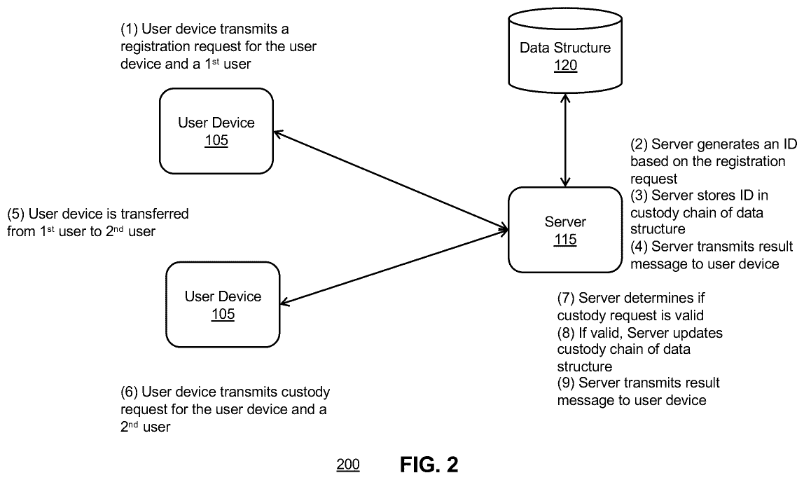

FIGS. 2-4 depict diagrams 200-400 schematically showing operations of the system 102. The diagrams 200-400 showing operations of the user device 105 and the system 102 applies to the user device 105 and the system 102 as described above with respect to FIG. 1.

FIG. 2 depicts a block diagram 200 schematically showing exemplary and optional operations of an exemplary embodiment of system 102 to register and maintain a custody chain for an ID in a data structure 120 of the system 102. The steps shown in FIG. 2 are optional, and any of these steps and system components may be omitted or modified, the step sequence may be changed, and the steps may optionally be performed by other devices in the system architecture.

In operation (1), the user device 105 transmits a registration request for the user device 105 and a first user. In some cases, the registration request includes data about the first user, data about the user device 105, and/or a plurality of assets (e.g., camera images from an asset generation device, whether integrated into the user device 105 or separate therefrom).

In operation (2), the server 115 generates an ID based on the registration request. For instance, the server 115 may generate a device ID based on the plurality of assets, as discussed herein.

In operation (3), the server 115 stores ID in custody chain of data structure 120. For instance, the server 115 may store the ID (encrypted) in association with an account ID associated with the first user.

In operation (4), the server 115 transmits a result message to user device 105. For instance, the server 115 may transmit a result message that indicates the first user is registered with the system 102.

In operation (5), the user device 105 (or asset generation device if not integrated into the user device 105) is transferred from the first user to a second user.

In operation (6), the user device 105 transmits custody request for the user device (or asset generation device if not integrated into the user device 105) and the second user.

In operation (7), the server 115 determines if the custody request is valid. For instance, the server 115 may notify the first user that a custody request has been received, and the like. The server 115 may adhere to policies regarding transfers of possession and the like. The server 115 may determine the custody request is valid if the request includes new assets (with time stamps within a threshold from the custody request), which can be a second factor authentication that the second user is in possession of the user device 105 (or asset generation device). The server 115 may determine the custody request is valid.

In operation (8), if the custody request is determined to be valid, the server 115 updates the custody chain of data structure 120. The server 115 may update an association of the ID to a user account. In the case the ID includes a user ID, the ID may be updated to reflect a change in user from the first user to the second user.

In operation (9), the server 115 transmits a result message to the user device 105. In the case the custody request was determined to be valid, the result message may indicate success in updating custody of the user device 105 (or asset generation device); in the case the custody request was determined to be not valid, the result message may indicate an error or denial to update custody of the user device 105 (or asset generation device).

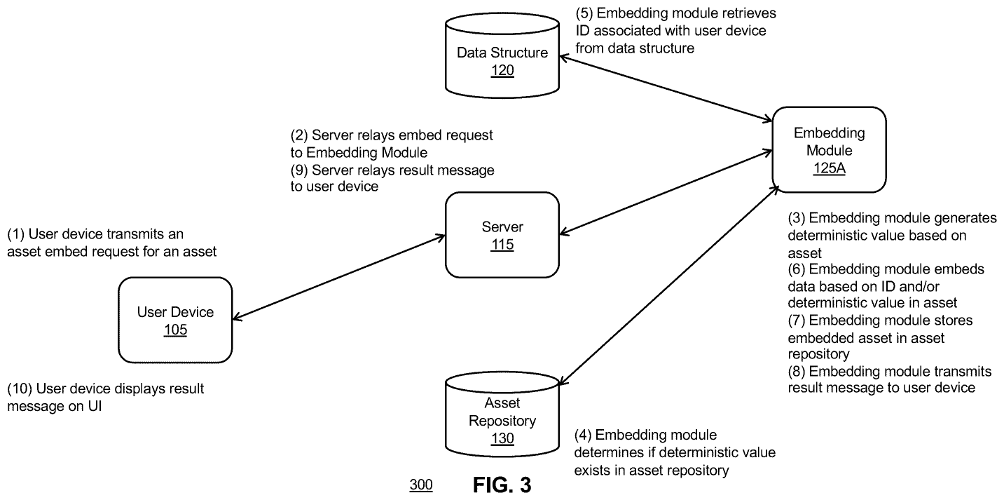

FIG. 3 depicts a block diagram 300 schematically showing operations of an exemplary embodiment of the system to generate validation-ready assets. The steps and system components shown in FIG. 3 are optional, and any of these steps and system components may be omitted or modified, the step sequence may be changed, and the steps may optionally be performed by other devices in the system architecture.

In operation (1), the user device 105 transmits an asset embed request for an asset. For instance, the asset embed request may include an initial asset, which may be any digital asset to have embedded therein an ID associated with a user and an asset hash of the digital asset.

In operation (2), the server 115 may relay the embed request to embedding module 125A. For instance, the server 115 may determine whether the embed request is properly formatted, the user associated with the user device 105 is logged in, and the like, and if fine, relay the embed request.

In operation (3), the embedding module 125A generates a deterministic value based on the asset. For instance, the embedding module 125A may modify certain pixels (e.g., least significant bits of pixel values of the certain pixels) to generate a modified asset, and determine a hash of the modified asset.

In operation (4), the embedding module 125A determines if the deterministic value exists in asset repository. For instance, the embedding module 125A may determine if the deterministic value matches at least deterministic value from a plurality of deterministic values, each determined by modifying least significant bits of pixels in a defined manner and hashing the modified asset.

In operation (5), the embedding module 125A retrieves an ID associated with user device 105 from the data structure 120. For instance, the embedding module 125A determines an account ID based on a user or the user device 105 that transmitted the embed request, and retrieves the ID stored in association with the account ID.

In operation (6), the embedding module 125A embeds data based on ID and/or deterministic value in the asset. For instance, the embedding module 125A may embed embedded data that is encrypted (at least in part), such that the embedded data includes the ID and/or the deterministic value.

In operation (7), the embedding module 125A stores the embedded asset in asset repository 130. For instance, the embedding module 125A may publish the embedded asset, provide the embedded asset to the user device 105, and the like.

In operation (8), the embedding module 125A transmits a result message to the user device 105. The embedding module 125A may transmit a result message including the embedded asset and/or an indicator of success of generating the embedded asset.

In operation (9), the server 115 relays the result message to the user device 105.

In operation (10), the user device 105 displays the result message on a user interface.

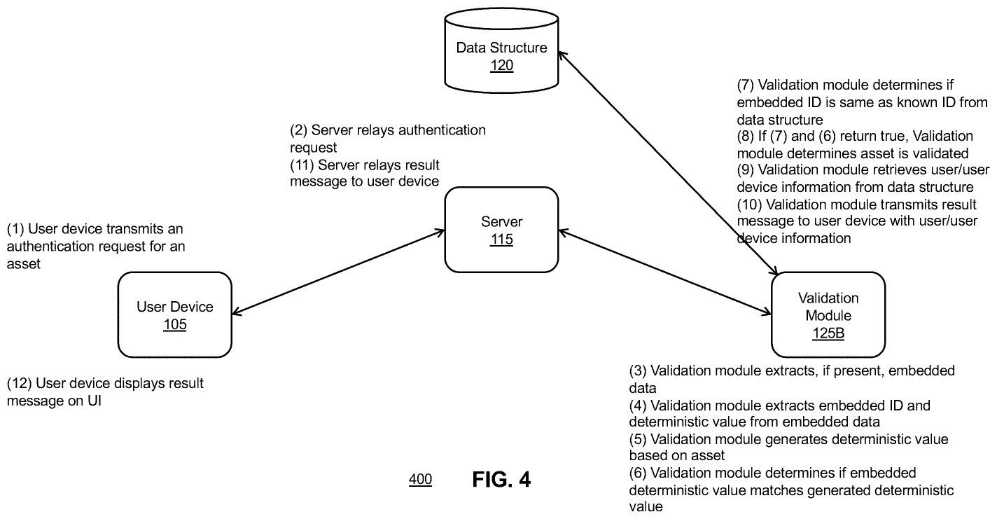

FIG. 4 depicts a block diagram 400 schematically showing operations of an exemplary embodiment of the system to validate information relating to assets. The steps and system components shown in FIG. 4 are optional, and any of these steps and system components may be omitted or modified, the step sequence may be changed, and the steps may optionally be performed by other devices in the system architecture.

In operation (1), the user device 105 transmits an authentication request for an asset. For instance, the authentication request may include the asset and a request for authentication (e.g., to confirm the asset is valid and/or provide data about the source) or a request for authentication against a claimed source (e.g., to confirm the asset is or is not the claimed source).

In operation (2), the server 115 relays the authentication request to the validation module 125B. For instance, the server 115 may determine whether the authentication request is properly formatted, the user associated with the user device 105 is logged in, and the like, and if fine, relay the authentication request.

In operation (3), the validation module 125B extracts, if present, embedded data. For instance, the validation module 125B may determine the asset includes embedded data by reading meta data, scanning content of the asset, or reading particular bits of the asset, as discussed herein.

In operation (4), the validation module 125B extracts embedded ID and embedded deterministic value from embedded data. For instance, the validation module 125B may decrypt the embedded data and extract an ID and deterministic value.

In operation (5), the validation module 125B generates a deterministic value based on asset. For instance, the validation module 125B may modify the asset (e.g., normalize certain bits of certain pixels) and hash the modified asset.

In operation (6), the validation module 125B determines if embedded deterministic value matches generated deterministic value. For instance, the validation module 125B may determine the asset was tampered if the hashes do not match; if they do match, the validation module 125B may return true for asset integrity.

In operation (7), the validation module 125B determines if embedded ID is same as a known ID from the data structure 120. For instance, the validation module 125B may search encrypted IDs of the data structure 120 with the embedded ID, and determine if any match; if so, the source is determined to be authenticate (and return true); if not, the source if not authenticated (or at least not registered) (and return false).

In operation (8), if (7) and (6) return true, the validation module 125B determines asset is validated. For instance, the validation module 125B may determine the asset is partially validated if the ID returns true and the asset hash returns false (e.g., asset was cropped), or if any return false, the validation module 125B does not validate the authenticity of the asset.

In operation (9), the validation module 125B retrieves user/user device information from the data structure 120. For instance, the validation module 125B may determine an account ID (via the ID), retrieve account settings based on the account ID, and retrieve user/user device data, in accordance with the account settings.

In operation (10), the validation module 125B transmits a result message to the user device 105 with user/user device information. For instance, the validation module 125B may include data authorized by the user to release in the result message.

In operation (11), the server 115 relays the result message to the user device 105.

In operation (12), the user device 105 displays the result message on a user interface.

### Example Embedding of Data Into an Asset

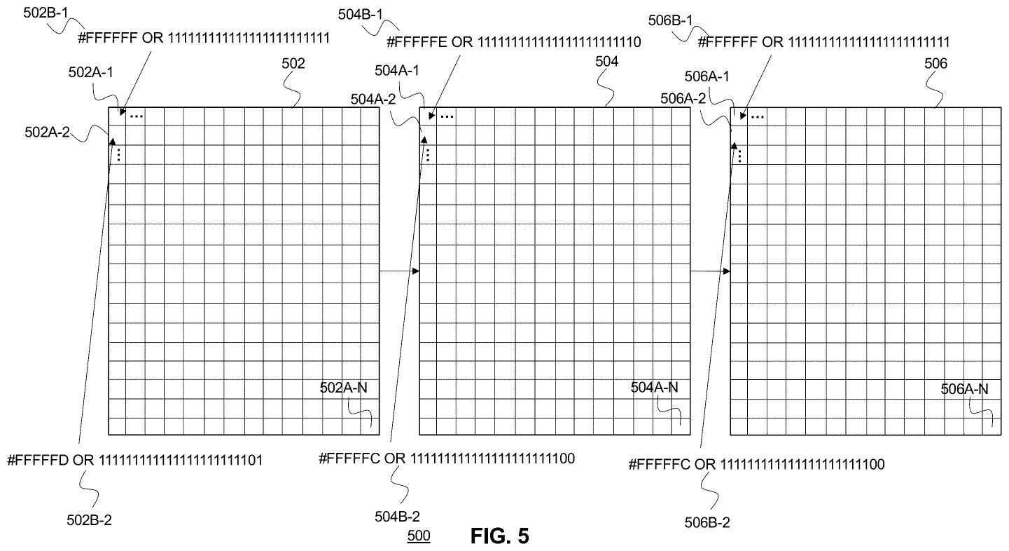

FIG. 5 depicts a diagram 500 schematically showing an example of how data may be embedded into assets. The embedding process depicted in FIG. 5 may be used by the systems and in the processes described above with respect to FIGS. 1-4.

In particular, diagram 500 shows an example process starting with an initial asset 502, that the embedding module 125A modifies to generate a modified asset 504, and the embedding module 125A modifies the modified asset 504 to generate an embedded asset 506 with embedded data embedded therein.

The initial asset 502 includes a plurality of pixels 502A-1 through 502A-N, the pixels having a corresponding pixel value 502B-1 through 502B-N. In this example case, a defined region (e.g., a top left corner) of the initial asset is where pixels are selected to embed data in least significant bits. Pixel 502A-1 and pixel 502A-2 each have pixel values 502B-1 (hex: FFFFFF) and 502B-2 (hex: FFFFFD).

The embedding module 125A may modify a least significant bit of each pixel selected, to thereby generate the modified asset 504. The modified asset 504 includes a plurality of pixels 504A-1 through 504A-N, the pixels having a corresponding pixel value 504B-1 through 504B-N. In this example case, pixel 504A-1 has had its pixel value changed from (hex: FFFFFF) to (hex: FFFFFE) and pixel 504A-2 has had its pixel value changed from (hex: FFFFFE) to (hex: FFFFFC). Thus, the least significant bits of pixel 504A-1 and pixel 504A-2 have been normalized in the modified asset 504.

The embedding module 125A may then embed embedded data into the least significant bits of each pixel selected, to thereby generate the embedded asset 506. The embedded asset 506 includes a plurality of pixels 506A-1 through 506A-N, the pixels having a corresponding pixel value 506B-1 through 506B-N. In this example case, pixel 506A-1 has had its pixel value changed from (hex: FFFFFE) to (hex: FFFFFF) and pixel 506A-2 has had its pixel value remain the same (hex: FFFFFC). Thus, the least significant bits of pixel 506A-1 and pixel 506A-2 embed data to validate the asset.

### Example Graphical User Interfaces

FIGS. 6A-6F depict graphical user interfaces 600A-600F for a registration process and a generation process for validation-ready assets. The graphical user interfaces 600A-600F for a registration process and a generation process for validation-ready assets applies to the user device 105 and the system 102 as described above with respect to FIGS. 1-5.

Graphical user interface 600A depicts a landing user interface that presents a first interactive element 602 and a second interface element 604. The first interactive element 602 and the second interface element 604 may be selectable by a user input on a user device 105 (displaying the landing user interface). The first interactive element 602 may be selected by a user to register with the system 102. The second interface element 604 may be selected by a user to validate an asset.

Graphical user interface 600B depicts a data entry user interface, in response to a user input selecting the first interactive element 602. The data entry user interface includes a data entry element 606. The data entry element 606 may be a text field to enter text regarding a user (e.g., a name).

Graphical user interface 600C depicts a settings user interface, in response to a user input inputting user data in the data entry element 606. The settings may include first toggle field 608, second toggle field 610, and third toggle field 612. The first toggle field 608 may publish user data on the system 102. The second toggle field 610 may publish validation of the user's assets, but may hide the user behind a handle. The third toggle field 612 may keep the user private (i.e., not publish the user, not publish user data, or publish validation of the user's assets)

Graphical user interface 600D depicts an upload user interface, in response to a user input selecting a toggle field from among the first toggle field 608, the second toggle field 610, and the third toggle field 612. The upload user interface includes an upload element 614 that allows a user input to drag and drop or browse a folder system of a user device 105 to select assets to provide the system 102.

Graphical user interface 600E depicts a embed request user interface, in response to a user input uploading assets via upload element 614. After the user input uploading the assets, the user device 105 may transmit a registration request to the server 115. The system 102 (e.g., the server 115) may then perform operations like operations (2) through (4) of FIG. 2. The embed request user interface includes an embed request element 616 that allows a user input to drag and drop or browse a folder system of a user device 105 to select and upload an asset to embed data into, thereby generating an embedded asset.

Graphical user interface 600F depicts a first result message user interface, in response to a user input selecting and uploading an asset. After the user input selecting and uploading the asset, the user device 105 may transmit an embed request to the server 115. The system 102 (e.g., the embedding module 125A) may then perform operations like operations (2) through (8) of FIG. 3. The result message user interface includes an embedded asset 618.

FIGS. 7A-7C depict graphical user interfaces 700A-700C for a validation process for validation-ready assets. The graphical user interfaces 700A-700C for a validation process for validation-ready assets applies to the user device 105 and the system 102 as described above with respect to FIGS. 1-5 and 6A-6F.

Graphical user interface 700A depicts the landing user interface that presents the first interactive element 602 and the second interface element 604. The first interactive element 602 and the second interface element 604 are the same as in graphical user interface 600A.

Graphical user interface 700B depicts an authentication request user interface, in response to a user input selecting the second interface element 604. After the user input selecting the second interface element 604, the user device 105 may display the authentication request user interface. The authentication request user interface may include an authenticate request element 702 that allows a user input to drag and drop or browse a folder system of a user device 105 to select and upload an asset to authenticate.

Graphical user interface 700C depicts a second result message user interface, in response to a user input selecting and uploading an asset to authenticate. After the user input selecting and uploading the asset, the user device 105 may transmit an authentication request to the server 115. The system 102 (e.g., the validation module 125B) may then perform operations like operations (3) through (10) of FIG. 4. The result message user interface includes the asset 704, fingerprinted data 706, and published data for the user 708 and 710.

### Example Routine(s)

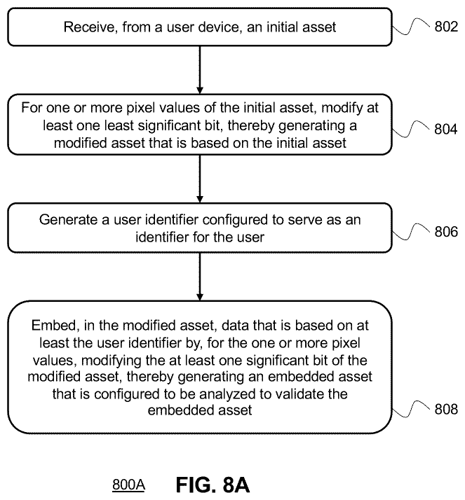

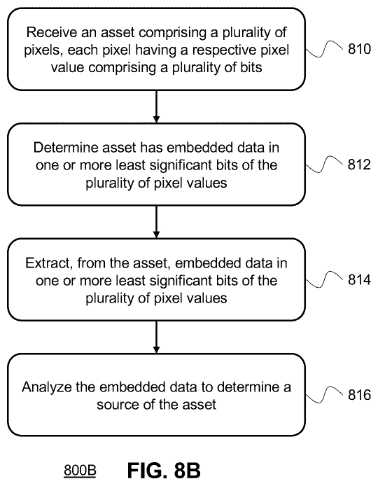

FIG. 8A depicts a flowchart of an exemplary routine 800A for generating validation-ready assets. In the routine 800A, the routine 800A may be performed by one or more systems, such as system 102. Specifically, the server 115 and the embedding module 125A may perform the routine 800A. The routine 800A for generating validation-ready assets applies to the user device 105 and the system 102 as described above with respect to FIGS. 1-5, 6A-6F, and 7A-7C.

The routine 800A may start at block 802, where the system 102 may receive, from a user device, an initial asset. For instance, the system 102 may receive an embed request from a user device that includes the initial asset, as discussed herein.

At block 804, the system 102 may for one or more pixel values of the initial asset, modify at least one least significant bit, thereby generating a modified asset that is based on the initial asset. For instance, the system 102 may select certain pixels and modify (e.g., normalize) bits of pixel values for those pixels, as discussed herein.

At block 806, the system 102 may generate a user identifier configured to serve as an identifier for the user. For instance, the system 102 may generate an ID (e.g., a user ID, a device ID, or combinations thereof), as discussed herein.

At block 808, the system 102 may embed, in the modified asset, data that is based on at least the user identifier by, for the one or more pixel values, modifying the at least one significant bit of the modified asset, thereby generating an embedded asset that is configured to be analyzed to validate the embedded asset. For instance, the system 102 may embed an ID and/or asset hash into the pixel values of the selected pixels, as discussed herein.

FIG. 8B depicts a flowchart of an exemplary routine 800B for validating information relating to assets. In the routine 800B, the routine 800B may be performed by one or more systems, such as the system 102. Specifically, the server 115 and the validation module 125B may perform the routine 800B. The routine 800B for validating information relating to assets applies to the user device 105 and the system 102 as described above with respect to FIGS. 1-5, 6A-6F, 7A-7C, and 8A.

The routine 800B may start at block 810, where the system 102 may receive an asset comprising a plurality of pixels, each pixel having a respective pixel value comprising a plurality of bits. For instance, the system 102 may receive an authentication request from a user device 105 that includes an asset to authenticate, as discussed herein.

At block 812, the system 102 may determine the asset has embedded data in one or more least significant bits of the plurality of pixel values. For instance, the system 102 may (1) read metadata of the asset; (2) scanning content of the asset for a fingerprint mark; or (3) reading bit values of the asset to see if a fingerprint bit sequence is matched, as discussed herein.

At block 814, the system 102 may extract, from the asset, embedded data in one or more least significant bits of the plurality of pixel values. For instance, the system 102 may select the same certain pixels (as in the embedding process) and copy bit values from pixel values for those pixels, as discussed herein.

At block 816, the system 102 may analyze the embedded data to determine a source of the asset. For instance, the system 102 may decrypt the embedded data, extract an ID and an asset hash from the embedded data, and determine whether the ID and asset hash are valid, as discussed herein.

### Computer System

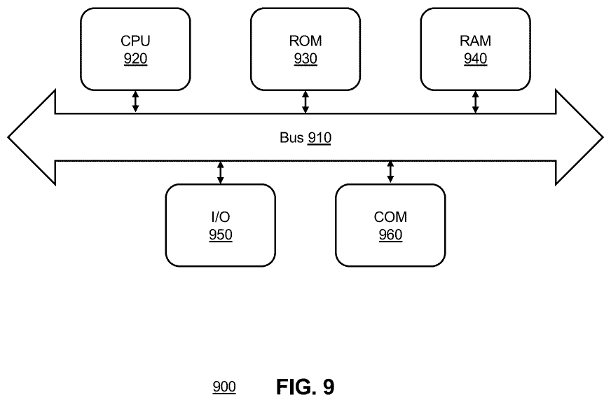

FIG. 9 depicts an example system that may execute techniques presented herein. FIG. 9 is a simplified functional block diagram of a computer that may be configured to execute techniques described herein, according to exemplary cases of the present disclosure. Specifically, the computer (or “platform” as it may not be a single physical computer infrastructure) may include a data communication interface 960 for packet data communication. The platform may also include a central processing unit (“CPU”) 920, in the form of one or more processors, for executing program instructions. The platform may include an internal communication bus 910, and the platform may also include a program storage and/or a data storage for various data files to be processed and/or communicated by the platform such as ROM 930 and RAM 940, although the system 900 may receive programming and data via network communications. The system 900 also may include input and output ports 950 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In some cases, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

### Terminology

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of ±10% in a stated value.

The term “exemplary” is used in the sense of “example” rather than “ideal.” As used herein, the singular forms “a,” “an,” and “the” include plural reference unless the context dictates otherwise.

### EXAMPLES

Clause 1. A system for generating validation-ready assets, the system comprising: one or more processors; and a memory storing instructions that, when executed by the one or more processors, are configured to cause the system to: receive, from a user device associated with a user, an initial asset; for one or more pixel values of the initial asset, modify at least one least significant bit, thereby generating a modified asset that is based on the initial asset; generate a user identifier configured to serve as an identifier for the user and/or the user device; and embed, in the modified asset, data that is based on at least the user identifier by, for the one or more pixel values, modifying the at least one least significant bit of the modified asset; wherein embedding the data in the modified asset generates an embedded asset that is configured to be analyzed to validate the embedded asset.

Clause 2. The system of Clause 1, wherein all pixel values of the embedded asset are less than 5% different than corresponding pixel values having a same position in the initial asset.

Clause 3. The system of any of Clauses 1-2, wherein the system is further configured to generate, using the modified asset, a deterministic value that is configured to serve as an asset identifier.

Clause 4. The system of Clause 3, wherein the deterministic value is a hash of the modified asset.

Clause 5. The system of any of Clauses 3-4, wherein the system is further configured to determine whether the deterministic value exists in a data repository comprising deterministic values associated with previously received assets.

Clause 6. The system of any of Clauses 3-5, wherein the embedded data comprises the deterministic value and the user identifier.

Clause 7. The system of any of Clauses 1-6, wherein the embedded data is encrypted.

Clause 8. The system of any of Clauses 1-7, wherein the user identifier is a statistic that is unique to a digital camera used by the user.

Clause 9. The system of Clause 8, wherein the statistic is generated by analyzing a photo response non-uniformity of a plurality of assets provided by the user device.

Clause 10. The system of any of Clauses 1-9, wherein analyzing the embedded asset to validate the embedded asset includes validating a source of the embedded asset.

Clause 11. The system of any of Clauses 1-10, wherein the system is further configured to: receive a request to validate a source of the embedded asset; extract from the embedded asset the embedded data; and analyze the embedded data to determine an assessed source of the embedded asset.

Clause 12. The system of Clause 11, wherein the system is further configured to: receive a claim regarding a claimed source of the embedded asset; compare the claimed source against the assessed source determined by analyzing the embedded data; and generate an assessment as to whether the claim regarding the claimed source of the embedded asset is valid.

Clause 13. The system of any of Clauses 11-12, wherein the embedded data comprises an asset identifier that is a hash of the modified asset.

Clause 14. The system of any of Clauses 11-13, wherein the system is further configured to generate a validation hash based on the embedded asset; extract an asset identifier from the embedded data; compare the validation hash to the asset identifier; and, based at least in part on the comparison of the validation hash to the asset identifier, determine whether the embedded information is valid.

Clause 15. The system of any of Clauses 1-14, wherein the initial asset is an image.

Clause 16. A computer-implemented method for generating validation-ready assets, comprising: receiving, from a user device associated with a user, an initial asset; for one or more pixel values of the initial asset, modifying at least one least significant bit, thereby generating a modified asset that is based on the initial asset; generating a user identifier configured to serve as an identifier for the user and/or the user device; and embedding, in the modified asset, data that is based on at least the user identifier by, for the one or more pixel values, modifying the at least one least significant bit of the modified asset; wherein embedding the data in the modified asset generates an embedded asset that is configured to be analyzed to validate the embedded asset.

Clause 17. The computer-implemented method of Clause 16, further comprising: generating, using the modified asset, a deterministic value that is configured to serve as an asset identifier.

Clause 18. The computer-implemented method of Clause 17, wherein the deterministic value is a hash of the modified asset.

Clause 19. The computer-implemented method of any of Clauses 17-18, further comprising: determining whether the deterministic value exists in a data repository comprising deterministic values associated with previously received assets.

Clause 20. The computer-implemented method of any of Clauses 17-19, wherein the embedded data comprises the deterministic value and the user identifier.

Clause 21. A system for validating information relating to assets, the system comprising: one or more processors; and a memory storing instructions that, when executed by the one or more processors, are configured to cause the system to: receive an asset comprising a plurality of pixels, each pixel having a respective pixel value comprising a plurality of bits; determine the asset has embedded data in one or more least significant bits of the plurality of pixel values; extract, from the asset, the embedded data in the one or more least significant bits of the plurality of pixel values; and analyze the embedded data to determine a source of the asset.

Clause 22. The system of Clause 21, wherein the system is further configured to: receive a claim regarding a claimed source of the asset; compare the claimed source against the source determined by analyzing the embedded data; and generate an assessment as to whether the claim regarding the claimed source of the asset is valid.

Clause 23. The system of any of Clauses 21-22, wherein the embedded data is encrypted, and the system is further configured to decrypt the embedded data using a cryptographic key associated with the asset.

Clause 24. The system of any of Clauses 21-23, wherein the embedded data comprises a source identifier, and the source identifier is configured to identify the source of the asset.

Clause 25. The system of Clause 24, wherein the source identifier is a statistic that is unique to a digital camera used by a user who is the source of the asset.

Clause 26. The system of Clause 25, wherein the statistic was generated by analyzing a photo response non-uniformity of a plurality of assets provided by the user.

Clause 27. The system of any of Clauses 21-26, wherein the embedded data comprises an asset identifier, and the asset identifier is configured to identify the asset in which the asset identifier is embedded.

Clause 28. The system of Clause 27, wherein the asset identifier is a hash of the asset, and the hash is generated before the embedded data is embedded in the asset.

Clause 29. The system of any of Clauses 27-28, wherein the system is further configured to: generate a deterministic value from the asset; extract the asset identifier from the embedded data; compare the deterministic value to the asset identifier; and, based at least in part on the comparison of the deterministic value to the asset identifier, determine whether the embedded data is valid.

Clause 30. The system of any of Clauses 21-29, wherein, to generate the asset, the system is configured to: receive an initial asset from a user device who is the source of the asset; and embed the embedded data in the one or more least significant bits.

Clause 31. The system of Clause 30, wherein all pixel values of the asset are less than 5% different than corresponding pixel values having same position in the initial asset.

Clause 32. The system of any of Clauses 30-31, wherein the system is further configured to, prior to the step of embedding the embedded data: modify the one or more least significant bits of the initial asset to generate a modified asset; and generate a hash of the modified asset; wherein the hash is included in the embedded data.

Clause 33. The system of any of Clauses 30-32, wherein the system is further configured to, prior to the step of embedding the embedded data: analyze a plurality of assets provided by the user and generate a photo response non-uniformity statistic; wherein the photo response non-uniformity statistic is included in the embedded data.

Clause 34. The system of any of Clauses 21-33, wherein the asset is an image.

Clause 35. A computer-implemented method for validating information relating to assets, comprising: receiving an asset comprising a plurality of pixels, each pixel having a respective pixel value comprising a plurality of bits; determining the asset has embedded data in one or more least significant bits of the plurality of pixel values; extracting, from the asset, the embedded data in the one or more least significant bits of the plurality of pixel values; and analyzing the embedded data to determine a source of the asset.

Clause 36. The computer-implemented method of Clause 35, wherein the embedded data comprises a source identifier, and the source identifier is configured to identify the source of the asset.

Clause 37. The computer-implemented method of Clause 36, wherein the source identifier is a statistic that is unique to a digital camera used by a user who is the source of the asset.

Clause 38. The computer-implemented method of Clause 37, wherein the statistic was generated by analyzing a photo response non-uniformity of a plurality of assets provided by the user.

Clause 39. The computer-implemented method of any of Clauses 35-38, wherein the embedded data comprises an asset identifier, and the asset identifier is configured to identify the asset in which the asset identifier is embedded.

Clause 40. The computer-implemented method of Clause 39, wherein the asset identifier is a hash of the asset, and the hash is generated before the embedded data is embedded in the asset.

Other aspects of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for generating validation-ready assets, the system comprising:
one or more processors; and
a memory storing instructions that, when executed by the one or more processors, are configured to cause the system to:
receive, from a user device associated with a user, an initial asset;
for one or more pixel values of the initial asset, modify at least one least significant bit, thereby generating a modified asset that is based on the initial asset;
generate a user identifier configured to serve as an identifier for the user and/or the user device; and
embed, in the modified asset, data that is based on at least the identifier by, for the one or more pixel values, modifying the at least one least significant bit of the modified asset;
wherein embedding the data in the modified asset generates an embedded asset that is configured to be analyzed to validate the embedded asset.

2. The system of claim 1, wherein all pixel values of the embedded asset are less than 5% different than corresponding pixel values having a same position in the initial asset.

3. The system of claim 1, wherein the system is further configured to generate, using the modified asset, a deterministic value that is configured to serve as an asset identifier.

4. The system of claim 3, wherein the deterministic value is a hash of the modified asset.

5. The system of claim 3, wherein the system is further configured to determine whether the deterministic value exists in a data repository comprising deterministic values associated with previously received assets.

6. The system of claim 3, wherein the embedded data comprises the deterministic value and the user identifier.

7. The system of claim 1, wherein the embedded data is encrypted.

8. The system of claim 1, wherein the user identifier is a statistic that is unique to a digital camera used by the user.

9. The system of claim 8, wherein the statistic is generated by analyzing a photo response non-uniformity of a plurality of assets provided by the user device.

10. The system of claim 1, wherein analyzing the embedded asset to validate the embedded asset includes validating a source of the embedded asset.

11. The system of claim 1, wherein the system is further configured to: receive a request to validate a source of the embedded asset; extract from the embedded asset the embedded data; and analyze the embedded data to determine an assessed source of the embedded asset.

12. The system of claim 11, wherein the system is further configured to: receive a claim regarding a claimed source of the embedded asset; compare the claimed source against the assessed source determined by analyzing the embedded data; and generate an assessment as to whether the claim regarding the claimed source of the embedded asset is valid.

13. The system of claim 11, wherein the embedded data comprises an asset identifier that is a hash of the modified asset.

14. The system of claim 11, wherein the system is further configured to generate a validation hash based on the embedded asset; extract an asset identifier from the embedded data; compare the validation hash to the asset identifier; and, based at least in part on the comparison of the validation hash to the asset identifier, determine whether the embedded data is valid.

15. The system of claim 1, wherein the initial asset is an image.

16. A computer-implemented method for generating validation-ready assets, comprising:
receiving, from a user device associated with a user, an initial asset;
for one or more pixel values of the initial asset, modifying at least one least significant bit, thereby generating a modified asset that is based on the initial asset;
generating a user identifier configured to serve as an identifier for the user and/or the user device; and
embedding, in the modified asset, data that is based on at least the user identifier by, for the one or more pixel values, modifying the at least one least significant bit of the modified asset;
wherein embedding the data in the modified asset generates an embedded asset that is configured to be analyzed to validate the embedded asset.

17. The computer-implemented method of claim 16, further comprising: generating, using the modified asset, a deterministic value that is configured to serve as an asset identifier.

18. The computer-implemented method of claim 17, wherein the deterministic value is a hash of the modified asset.

19. The computer-implemented method of claim 17, further comprising: determining whether the deterministic value exists in a data repository comprising deterministic values associated with previously received assets.

20. The computer-implemented method of claim 17, wherein the embedded data comprises the deterministic value and the user identifier.
